(19) United States
(12) Patent Application Publication
(10) Pub. No.: US 2020/0388099 A1
(43) Pub. Date: Dec. 10, 2020

(54) SMART VENDING APPARATUS, AND CONTROL METHOD THEREOF

(71) Applicant: HEFEI MIDEA INTELLIGENT TECHNOLOGIES CO., LTD., Hefei (CN)

(72) Inventors: Tao JI, Hefei (CN); Jiang DAI, Hefei (CN); Da XU, Hefei (CN)

(21) Appl. No.: 16/770,549

(22) PCT Filed: Jul. 5, 2018
(86) PCT No.: PCT/CN2018/094665

§ 371 Date: Jun. 5, 2020

(30) Foreign Application Priority Data
Dec. 6, 2017 (CN) 201711276732.3

(51) Int. Cl. G07F 9/10; G07F 9/02; G07F 11/62

(52) U.S. Cl. CPC G07F 9/105; G07F 11/62; G07F 9/026

(57) ABSTRACT

A smart vending apparatus and a control method thereof. The apparatus includes: a cabinet (10) provided with a product shelf (102) used to display items for sale, the items carrying item information tags. A main control system is provided within the cabinet (10) and has a tag scanner (304) and a communication device (306) being respectively connected to a central processor (302) thereof. Upon receiving a door-opening instruction sent by the server after the server authenticates the identity information, the central processor (302) controls the door (20) to switch from a closed state to an open state. After the door (20) switches from the open state to the closed state, the tag scanner (304) scans all item information tags in the cabinet (10) to determine current inventory information.

### CROSS-REFERENCE TO RELATED APPLICATION

The present disclosure claims the priority to Chinese Patent Application No. 201711276732.3, entitled “Smart Vending Apparatus and Control Method Thereof”, filed in the China National Intellectual Property Administration on Dec. 6, 2017, the entire contents of which are incorporated herein by reference.

### FIELD

The present disclosure relates to the technical field of electrical appliances, in particular to a smart vending apparatus and a control method thereof.

### BACKGROUND

At present, the existing vending machines are generally designed for specific items. For example, for a computer-controlled unattended vending machine that provides automatic checkout, the door is normally closed and items for sale are held by a tray on a product shelf, and when paid, a sold item is sent out by a transmission mechanism of the apparatus. However, such vending machine may employ a transmission mechanism with a large volume and is inconvenient for users to operate.

Besides, some apparatus are capable of monitoring items therein, for example, a storage cabinet having a plurality of RFID (Radio Frequency Identification) readers, requires a plurality of RFID scanners, among which a static RFID scanner scans all RFID tag information in the cabinet when the door is closed, and a processing RFID scanner scans RFID tags of the items when the door is opened and thus operates as a monitor for the items in the storage cabinet, i.e., different RFID scanners are used for scanning the items when the door of the storage cabinet is opened and closed, so the operation is complicated and inconvenient.

Therefore, how to provide a more intelligent vending solution which is simplified in operation and convenient for users to use so as to improve user experience has become an urgent technical problem to be solved.

### SUMMARY

The present disclosure aims to solve at least one of the technical problems existing in the prior art or related art.

Therefore, an object of the present disclosure is to provide a novel smart vending apparatus which allows a user to open a door by scanning an identity information tag of the apparatus, select items for sale at will, and pay the items via a server, so that user operation is facilitated while a good signal shielding effect, a low error rate in item settlement as well as a high safety factor are achieved, thereby effectively improving user experience.

Another object of the present disclosure is to provide a control method of the smart vending apparatus, and a computer-readable storage medium.

To achieve at least one of the above objects, according to a first aspect of the present disclosure, a smart vending apparatus is provided, comprising: a cabinet having an outer housing and a cabinet side frame both providing an electromagnetic shielding effect, wherein the cabinet has an inner wall made of non-metallic material without an electromagnetic shielding effect, and the cabinet is provided with at least one layer of product shelves therein used to display items for sale, the items for sale carrying corresponding item information electronic tags; a door peripherally provided with a door side frame and centrally provided with a transparent window, wherein a handle is provided at a middle position on one side of the door side frame, the door side frame and the transparent window both provide an electromagnetic shielding effect and are connected into an integral body without any electromagnetic leakage gaps, the door is installed on the cabinet, a sealing ring providing an electromagnetic shielding effect is provided between the door side frame and the cabinet side frame, the cabinet, the door and the sealing ring form an integral body without any electromagnetic leakage gaps when the door is in a closed state, and the door is provided with an identity information tag to be scanned by a mobile terminal apparatus to acquire identity information of the smart vending apparatus, wherein the identity information is a piece of encrypted information; and a main control system provided within the cabinet and comprising: a central processor, a memory device, a tag scanner and a communication device, the tag scanner and the communication device both connected to the central processor; wherein the communication device is used to establish a communication connection between the central processor and the server; the central processor is used to control the door to switch from the closed state to an open state upon receiving a door-opening instruction sent by the server after the server authenticates the identity information; and the tag scanner is used to scan all item information tags in the cabinet after the door switches from the open state to the closed state to determine current inventory information of the smart vending apparatus, wherein the current inventory information is stored in a memory device.

In this technical solution, the door and the cabinet of the smart vending apparatus form a closed space, the items for sale carrying respective item information tags are arranged on the at least one layer of product shelves in the cabinet, the door of the smart vending apparatus is normally in the closed state, and the identity information tag of the smart vending apparatus is arranged on one side, facing away from inner space of the cabinet, of the door; in particular use, a user scans the identity information tag with a mobile terminal apparatus to acquire the identity information of the smart vending apparatus so as to be associated to purchase the items for sale, specifically, the acquired identity information is sent to a server associated with both the smart vending apparatus and the mobile terminal apparatus, when the server authenticates the identity information, a door-opening instruction is sent to the central processor of the main control system via a communication device of the main control system of the smart terminal apparatus, then the central processor controls the door of the smart vending apparatus to be opened to allow the user to take away an item for sale to be purchased, and after the user takes away the item and the door is closed, the tag scanner of the main control system scans item information tags corresponding to all remaining items for sale currently on the product shelves to figure out current inventory information in the smart vending apparatus and stores the current inventory information obtained each time into the memory device; in this way, an inventory of items for sale in the smart vending apparatus is able to be acquired with one tag scanner provided therein, and the smart vending apparatus allows a user to select an item he/she needs by opening the door of the smart vending apparatus, so that a transmission mechanism for outputting the item selected by the user from the smart vending apparatus is not needed, and accordingly it is not necessary to fix the items for sale at specific positions of the product shelves for the sake of accurate output of the transmission mechanism, thereby greatly expanding the storage space of the smart vending apparatus, reducing the production cost of the apparatus, facilitating users' purchase operation with simplicity and convenience, effectively improving user experience and providing great convenience for the life of users; besides, in order to ensure that radio frequency signals within the closed space formed by the door and the cabinet do not leak to the outside to cause mistake scanning of items, the outer housing and the cabinet side frame of the cabinet and the door side frame and the transparent window of the door are all configured to provide an electromagnetic shielding effect, and the sealing ring provided between the door side frame and the cabinet side frame also provide an electromagnetic shielding effect, so that when the door is closed, an electromagnetic shielded space without any electromagnetic leakage gaps is formed within the smart vending apparatus, while the inner wall of the cabinet is made of non-metallic material without an electromagnetic shielding effect and will not influence item settlement, thereby achieving a good signal shielding effect of the smart vending apparatus as well as a low error rate in item settlement, and thus improving the safety coefficient of the apparatus.

Wherein, the item information tags carried by and in one-to-one correspondence to the items for sale comprise information such as names, prices, categories, valid periods and the like, and the identity information contained in the identity information tag of the smart vending apparatus may be information such as an apparatus number corresponding to the smart vending apparatus and the like which is unique for the identity of the smart vending apparatus.

In the above technical solution, optionally, the central processor is further used to compare the current inventory information with stored historical inventory information to determine a sold item taken away by a user after the door is switched from the closed state to the open state, and the communication device is further used to send item information of the sold item to the server to allow the server to generate corresponding charging information according to the item information of the sold item and carry out charge settlement with the mobile terminal apparatus according to the charging information; or the communication device is further used to send the current inventory information to the server to allow the server to compare the current inventory information with historical inventory information before the door is opened to determine a sold item, generate corresponding charging information according to item information of the sold item, and carry out charge settlement with the mobile terminal apparatus according to the charging information.

In this technical solution, the central processor of the smart vending apparatus determines a sold item taken away by the user (i.e., an item removed from the cabinet at the current time) according to comparison between the current remaining inventory information after the user takes away the sold item and the historical inventory information, and the item information (such as quantity and price) in the item information tag corresponding to the sold item is sent by the communication device to the server to allow the server to generate charging information about the sold item; or the current inventory information in the smart vending apparatus may be directly sent by the communication device to the server to determine the sold item, that is, the server determines the sold item taken away by the user according to comparison between the current remaining inventory information after the user takes away the sold item and the historical inventory information, and further generates charging information of the sold item according to the item information in the item information tag corresponding to the sold item; further, a charge operation for the sold item is specifically completed by the server to carry out charge settlement with the mobile terminal apparatus of the user according to the generated charging information, so that the user pays after taking out the item to be purchased, and the situation where the user cannot normally take the item after paying due to failure of the transmission mechanism in the existing vending apparatus is able to be effectively prevented, thereby further improving the user experience.

In any of the above technical solutions, optionally, the main control system further comprises: a power supply device, a load control device and a detection device; wherein the power supply device is used to provide a working power supply for the central processor, the load control device, the communication device and the tag scanner; the load control device is connected to the central processor; and the detection device is connected to the central processor and is used to detect work environment parameters within the cabinet and an open/closed state of the door.

In this technical solution, the main control system of the smart vending apparatus further comprises the load control device for controlling on/off states of relevant components of the smart vending apparatus according to relevant control instructions of the central processor, and the detection device for detecting work environment parameters within the cabinet of the smart vending apparatus and an open/closed state of the door, so that the environment condition within the cabinet is able to be adjusted in real time to provide a proper storage environment for items for sale therein so as to ensure the quality of the items, and the current inventory information within the smart vending apparatus is able to be figured out in time according to the switch of the open/closed state of the door; furthermore, the main control system further comprises the power supply device used to provide a working power supply for the central processor, the load control device, the communication device and the tag scanner, and specifically, the power supply device may obtain power from commercial power.

In any of the above technical solutions, optionally, the smart vending apparatus further comprises: a lock closing mechanism provided at a middle position of the handle and connected to the load control device, wherein the load control device is used to control an open/closed state of the lock closing mechanism, and the lock closing mechanism comprises a main lock part and a lock catch, wherein the main lock part is installed on the cabinet, and the lock catch is installed on the door.

In this technical solution, the cabinet and the door of the smart vending apparatus may be opened and closed through cooperation of the main lock part and the lock catch of the lock closing mechanism, specifically, the lock closing mechanism is correspondingly opened or closed when the load control device receives a corresponding unlocking or locking instruction from the central processor so as to ensure the safety of items for sale in the cabinet of the smart vending apparatus and prevent unnecessary loss to merchants, wherein the main lock part and the lock catch of the lock closing mechanism may be optionally provided on the cabinet and the door, respectively.

In any of the above technical solutions, optionally, the smart vending apparatus further comprises a lighting device provided within the cabinet and connected to the load control device, wherein the load control device is used to control an on/off state of the lighting device.

In this technical solution, in order to meet shopping needs of users in a dark environment with poor light, the smart vending apparatus may be provided with a lighting device, such as an LED (Light Emitting Diode) lighting lamp and the like, and specifically, the lighting device is correspondingly turned on or off when the load control device receives a corresponding light-on or light-off instruction from the central processor.

Further, in the above technical solution, the lighting device of the smart vending apparatus may always be in a lighting work state when the smart vending apparatus is in a dark environment with poor light, or may enter the lighting work state when the door of the smart vending apparatus is opened and stop lighting when the door is locked with the cabinet.

In any of the above technical solutions, optionally, the smart vending apparatus further comprises a cooling system provided within the cabinet and connected to the load control device, wherein the load control device is used to control an on/off state of the cooling system.

In this technical solution, in order to meet quality guarantee and fresh-keeping demands of items for sale placed in the cabinet of the smart vending apparatus, the smart apparatus may be provided with a cooling system to appropriately lower the environment temperature within the cabinet, and specifically, the cooling system correspondingly starts cooling or stops cooling when the load control device receives a corresponding start or stop instruction from the central processor.

In any of the above technical solutions, optionally, the item information tag comprises an RFID tag, and the tag scanner is an RFID scanner.

In this technical solution, the corresponding tag scanner and item information tags may be configured as an RFID scanner and RFID tags, respectively, so as to identify a specific target and read and write relevant data by means of radio signals based on the radio frequency identification technology without establishing mechanical or optical contact between the tag scanner and the item information tags, so that the completeness of remaining items for sale in the cabinet scanned by the tag scanner is ensured, and thus generated inventory information is highly accurate.

In any of the above technical solutions, optionally, the identity information tag comprises a two-dimensional code or NFC.

In this technical solution, the identity information tag which is provided on the door and contains the identity information of the smart vending apparatus may be presented in a form of a two-dimensional code or NFC (Near Field Communication) so as to facilitate near field scanning identification by the mobile terminal apparatus of the user; and of course, the identity information tag may also be in a form of a tag which is able to be identified by the mobile terminal apparatus, such as an RFID tag, an optical tag, etc.

In any of the above technical solutions, optionally, the sealing ring is made of conductive rubber and is installed on the door side frame and/or the cabinet side frame through snapping-in, bonding or screw fixing.

In this technical solution, the sealing ring may be specifically made of conductive rubber, and as conductive rubber is formed by conductive particles, such as silver-plated glass, silver-plated aluminum, silver, etc., uniformly distributed in silicone rubber, a good conductive property may be achieved by forcing the conductive particles into contact under pressure, thereby providing both sealing and electromagnetic shielding effects; and the conductive rubber may be installed on the door side frame and/or the cabinet side frame in various ways.

In any of the above technical solutions, optionally, the sealing ring is made of a metal braided hose with a flexible plastic tube inserted therein, and the metal braided hose is installed on the door side frame and/or the cabinet side frame through bonding or screw fixing.

In this technical solution, the sealing ring is formed by inserting the flexible plastic tube into the metal braided hose, thereby providing both sealing and electromagnetic shielding effects; and metal braided hose may be installed on the door side frame and/or the cabinet side frame in various ways.

According to a second aspect of the present disclosure, a control method of a smart vending apparatus is provided and is used for the smart vending apparatus of any one of the above technical solutions of the first aspect, the control method comprising the following steps of: when a communication device receives a door-opening instruction from a server, controlling, by a central processor, a door of the smart vending apparatus to switch from a closed state to an open state; when the door is switched from the open state to the closed state again, scanning, by a tag scanner, item information tags of all remaining items for sale on a product shelf of the cabinet to generate current inventory information within the cabinet; and comparing, by the central processor, the current inventory information with historical inventory information before the door is opened to determine a sold item; and sending, by the communication device, item information of the sold item to the server to allow the server to generate corresponding charging information according to the item information of the sold item and carry out charge settlement with a mobile terminal apparatus according to the charging information.

In this technical solution, when a user needs to purchase an item for sale in the cabinet of the smart vending apparatus, the central processor controls the door of the smart vending apparatus to be opened when the communication device receives the door-opening instruction sent by the server to allow the user to take away the item for sale to be purchased, and after the user takes away the item and the door is closed, the tag scanner of the main control system scans item information tags corresponding to all remaining items for sale currently on the product shelf to figure out current inventory information in the smart vending apparatus; besides, the outer housing and the cabinet side frame of the cabinet and the door side frame and the transparent window of the door of the smart vending apparatus are all configured to provide an electromagnetic shielding effect, and the sealing ring provided between the door side frame and the cabinet side frame also provides an electromagnetic shielding effect, so that when the door is closed, an electromagnetic shielded space without any electromagnetic leakage gaps is formed within the smart vending apparatus, and it is ensured that radio frequency signals within the closed space formed by the door and the cabinet do not leak to the outside to cause mistake scanning of items, while the inner wall of the cabinet is made of non-metallic material without an electromagnetic shielding effect and will not influence item settlement, thereby achieving a good signal shielding effect of the smart vending apparatus as well as a low error rate in item settlement, and thus improving the safety coefficient of the apparatus; in this way, an inventory of items for sale in the smart vending apparatus is able to be acquired with one tag scanner provided therein, and the smart vending apparatus allows a user to select an item he/she needs by opening the door of the smart vending apparatus, so that a transmission mechanism for outputting the item selected by the user from the smart vending apparatus is not needed, and accordingly it is not necessary to fix the items for sale at specific positions of the product shelf for the sake of accurate output of the transmission mechanism, thereby greatly expanding the storage space of the smart vending apparatus, reducing the production cost of the apparatus, facilitating users' purchase operation with simplicity and convenience, effectively improving user experience and providing convenience for the life of users.

Further, the central processor of the smart vending apparatus may determine a sold item taken away by the user (i.e., an item removed from the cabinet at the current time) according to comparison between the current remaining inventory information after the user takes away the sold item and the historical inventory information, and the item information (such as quantity and price) in the item information tag corresponding to the sold item is sent by the communication device to the server; and a charge operation for the sold item is specifically completed by the server to carry out charge settlement with the mobile terminal apparatus of the user according to the generated charging information, so that the user pays after taking out the item to be purchased, and the situation that the user cannot normally take the item after paying due to failure of the transmission mechanism in the existing vending apparatus is able to be effectively prevented, thereby further improving the user experience.

In the above technical solution, optionally, the door-opening instruction is generated when the server authenticates identity information of a user, determines that a previous charge settlement of the user is completed and authenticates identity information of the smart vending apparatus that the mobile terminal apparatus acquires by scanning an identity information tag on the door, wherein the identity information of the user comprises WeChat account information and/or Alipay account information.

In this technical solution, before the smart vending apparatus opens its door according to a door-opening instruction, a user needs to scan an identity information tag provided on the door of the smart vending apparatus with his/her mobile terminal apparatus to obtain identity information of the smart vending apparatus, and the identity information is sent to a server associated with both the mobile terminal apparatus and the smart vending apparatus for authentication, and when the server authenticates the identity information and also authenticates identity information of the user and determines that a previous charge settlement of the user is completed, a corresponding door-opening instruction is generated, so that the accuracy of charging is ensured, the user is prompted to settle the charge in time, and the loss of merchants is reduced.

In any of the above technical solutions, optionally, after the current inventory information within the cabinet is generated, the control method of the smart vending apparatus further comprises the following steps of: detecting whether a quantity of items contained in the current inventory information is smaller than a preset quantity threshold or not; and if so, prompting to replenish the smart vending apparatus with items for sale.

In this technical solution, whether to prompt a merchant to make replenishment or not may be determined according to a result of comparison between the quantity of items contained in the current inventory information which is figured out and generated after each sale and a preset quantity threshold, and specifically, it may prompt that the smart vending apparatus needs replenishment with the items for sale when the quantity of the items is smaller than the preset quantity threshold, thereby ensuring sufficient supply of the items for sale stored in the cabinet of the smart vending apparatus.

Wherein, the value of the preset quantity threshold may be specifically set according to the volume capacity of the cabinet of the smart vending apparatus so as to facilitate inventory statistics of items for sale.

In any of the above technical solutions, optionally, after the current inventory information within the cabinet is generated, the control method of the smart vending apparatus further comprises the following steps of: according to a quantity of items contained in the current inventory information and a consumption rate of the items, prompting a replenishment time to replenish the smart vending apparatus with items for sale.

In this technical solution, a replenishment time to replenish the smart vending apparatus with items for sale may be prompted according to the quantity of items contained in the current inventory information which is figured out and generated after each sale and the consumption rate of the items, so that the smart vending apparatus is able to be replenished in time before the items for sale are sold out, thereby ensuring sufficient supply of the items for sale stored in the cabinet of the smart vending apparatus.

According to a third aspect of the present disclosure, a control method of a smart vending apparatus is provided and is used for the smart vending apparatus of any one of the above technical solutions of the first aspect, the control method comprising the following steps of: when a communication device receives a door-opening instruction from a server, controlling, by a central processor, a door of the smart vending apparatus to switch from a closed state to an open state; when the door is switched from the open state to the closed state again, scanning, by a tag scanner, item information tags of all remaining items for sale on a product shelf of the cabinet to generate current inventory information within the cabinet; and sending, by the communication device, the current inventory information to the server to allow the server to compare the current inventory information with historical inventory information before the door is opened to determine a sold item, generate corresponding charging information according to item information of the sold item, and carry out charge settlement with a mobile terminal apparatus according to the charging information.

In this technical solution, when a user needs to purchase an item for sale in the cabinet of the smart vending apparatus, the central processor controls the door of the smart vending apparatus to be opened when the communication device receives the door-opening instruction sent by the server to allow the user to take away the item for sale to be purchased, and after the user takes away the item and the door is closed, the tag scanner of the main control system scans item information tags corresponding to all remaining items for sale currently on the product shelf to figure out current inventory information in the smart vending apparatus; besides, the outer housing and the cabinet side frame of the cabinet and the door side frame and the transparent window of the door of the smart vending apparatus are all configured to provide an electromagnetic shielding effect, and the sealing ring provided between the door side frame and the cabinet side frame also provides an electromagnetic shielding effect, so that when the door is closed, an electromagnetic shielded space without any electromagnetic leakage gaps is formed within the smart vending apparatus, and it is ensured that radio frequency signals within the closed space formed by the door and the cabinet do not leak to the outside to cause mistake scanning of items, while the inner wall of the cabinet is made of non-metallic material without an electromagnetic shielding effect and will not influence item settlement, thereby achieving a good signal shielding effect of the smart vending apparatus as well as a low error rate in item settlement, and thus improving the safety coefficient of the apparatus; in this way, an inventory of items for sale in the smart vending apparatus is able to be acquired with one tag scanner provided therein, and the smart vending apparatus allows a user to select an item he/she needs by opening the door of the smart vending apparatus, so that a transmission mechanism for outputting the item selected by the user from the smart vending apparatus is not needed, and accordingly it is not necessary to fix the items for sale at specific positions of the product shelf for the sake of accurate output of the transmission mechanism, thereby greatly expanding the storage space of the smart vending apparatus, reducing the production cost of the apparatus, facilitating users' purchase operation with simplicity and convenience, effectively improving user experience and providing convenience for the life of users.

Further, the current inventory information in the smart vending apparatus may be directly sent by the communication device of the smart vending apparatus to the server to determine the sold item, that is, the server determines the sold item taken away by the user according to comparison between the current remaining inventory information after the user takes away the sold item and the historical inventory information, and further generates charging information of the sold item according to the item information in the item information tag corresponding to the sold item; and a charge operation for the sold item is specifically completed by the server to carry out charge settlement with the mobile terminal apparatus of the user according to the generated charging information, so that the user pays after taking out the item to be purchased, and the situation that the user cannot normally take the item after paying due to failure of the transmission mechanism in the existing vending apparatus is able to be effectively prevented, thereby further improving the user experience.

In the above technical solution, optionally, the door-opening instruction is generated when the server authenticates identity information of a user, determines that a previous charge settlement of the user is completed and authenticates identity information of the smart vending apparatus that the mobile terminal apparatus acquires by scanning an identity information tag on the door, wherein the identity information of the user comprises WeChat account information and/or Alipay account information.

In this technical solution, before the smart vending apparatus opens its door according to a door-opening instruction, a user needs to scan an identity information tag provided on the door of the smart vending apparatus with his/her a mobile terminal apparatus to obtain identity information of the smart vending apparatus, and the identity information is sent to a server associated with both the mobile terminal apparatus and the smart vending apparatus for authentication, and when the server authenticates the identity information and also authenticates identity information of the user and determines that a previous charge settlement of the user is completed, a corresponding door-opening instruction is generated, so that the accuracy of charging is ensured, the user is prompted to settle the charge in time, and the loss of merchants is reduced.

In any of the above technical solutions, optionally, after the current inventory information within the cabinet is generated, the control method of the smart vending apparatus further comprises the following steps of: detecting whether a quantity of items contained in the current inventory information is smaller than a preset quantity threshold or not; and if so, prompting to replenish the smart vending apparatus with items for sale.

In this technical solution, whether to prompt a merchant to make replenishment or not may be determined according to a result of comparison between the quantity of items contained in the current inventory information which is figured out and generated after each sale and a preset quantity threshold, and specifically, it may prompt that the smart vending apparatus needs replenishment with the items for sale when the quantity of the items is smaller than the preset quantity threshold, thereby ensuring sufficient supply of the items for sale stored in the cabinet of the smart vending apparatus.

Wherein, the value of the preset quantity threshold may be specifically set according to the volume capacity of the cabinet of the smart vending apparatus so as to facilitate inventory statistics of items for sale.

In any of the above technical solutions, optionally, after the current inventory information within the cabinet is generated, the control method of the smart vending apparatus further comprises the following steps of: according to a quantity of items contained in the current inventory information and a consumption rate of the items, prompting a replenishment time to replenish the smart vending apparatus with items for sale.

In this technical solution, a replenishment time to replenish the smart vending apparatus with items for sale may be prompted according to the quantity of items contained in the current inventory information which is figured out and generated after each sale and the consumption rate of the items, so that the smart vending apparatus is able to be replenished in time before the items for sale are sold out, thereby ensuring sufficient supply of the items for sale stored in the cabinet of the smart vending apparatus.

According to a fourth aspect of the present disclosure, a computer readable storage medium having stored thereon a computer program which, when executed by a processor, carries out the steps of the control method of the smart vending apparatus according to any one of the technical solutions of the second and third aspects described above, is provided.

Additional aspects and advantages of the disclosure will be set forth in part in the description which follows and, in part, will be obvious from the description, or may be learned by practice of the disclosure.

### BRIEF DESCRIPTION OF THE DRAWINGS

The above and/or additional aspects and advantages of the present disclosure will become apparent and readily appreciated from the following description of the embodiments taken in conjunction with the accompanying drawings:

FIG. 1 is a schematic block diagram illustrating a smart vending apparatus according to a first embodiment of the present disclosure;

FIG. 2 is a schematic diagram illustrating a smart vending apparatus according to a second embodiment of the present disclosure;

FIG. 3 is a schematic diagram illustrating a main control system of the smart vending apparatus shown in FIG. 2;

FIG. 4 is a flowchart illustrating a control method of the smart vending apparatus according to the first embodiment of the present disclosure; and

FIG. 5 is a flowchart illustrating a control method of the smart vending apparatus according to the second embodiment of the present disclosure.

### DETAILED DESCRIPTION

In order that the above objects, features and advantages of the present disclosure may be more clearly understood, the present disclosure will be described in further detail with reference to the accompanying drawings and detailed description. It should be noted that the embodiments and features in the embodiments of the present application may be combined with one another without conflict.

In the following description, numerous specific details are set forth in order to provide a thorough understanding of the present disclosure, but the disclosure may be practiced otherwise than as described herein, and therefore, the scope of the disclosure is not limited to the specific embodiments disclosed below.

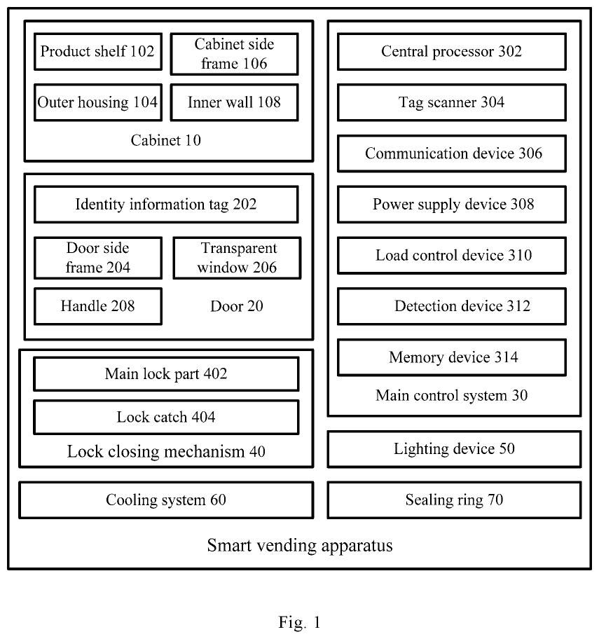

Smart vending apparatus according to embodiments of the present disclosure will be described below in detail with reference to FIGS. 1 to 3.

As shown in FIG. 1, a smart vending apparatus according to a first embodiment of the present disclosure comprises: a cabinet 10, a door 20, a main control system 30 provided within the cabinet 10, and a sealing ring 70 providing an electromagnetic shielding effect, and the main control system 30 comprises a central processor 302, a tag scanner 304, a communication device 306, and a memory 314, the tag scanner 304 and the communication device 306 both connected to the central processor 302.

Wherein, the cabinet 10 has an outer housing 104 and a cabinet side frame 106 both providing an electromagnetic shielding effect, the cabinet 10 has an inner wall 108 made of non-metallic material without an electromagnetic shielding effect, and the cabinet 10 is provided therein with at least one layer of product shelves 102 used to display items for sale, the items for sale carrying corresponding item information electronic tags; the door 20 is peripherally provided with a door side frame 204 and centrally provided with a transparent window 206, a handle 208 is provided at a middle position on one side of the door side frame 204, the door side frame 204 and the transparent window 206 both provide an electromagnetic shielding effect and are connected into an integral body without any electromagnetic leakage gaps, the door 20 is installed on the cabinet 10, a sealing ring 70 providing an electromagnetic shielding effect is provided between the door side frame 204 and the cabinet side frame 106, the cabinet 10, the door 20 and the sealing ring 70 form an integral body without any electromagnetic leakage gaps when the door 20 is in a closed state, and the door 20 is provided with an identity information tag 202 to be scanned by a mobile terminal apparatus to acquire identity information of the smart vending apparatus, wherein the identity information is a piece of encrypted information; and the communication device 306 is used to establish a communication connection between the central processor 302 and the server, the central processor 302 is used to control the door 20 to switch from the closed state to an open state upon receiving a door-opening instruction sent by the server after the server authenticates the identity information, and the tag scanner 304 is used to scan all item information tags in the cabinet 10 after the door 20 switches from the open state to the closed state to determine current inventory information of the smart vending apparatus, wherein the current inventory information is stored in a memory device 314.

In this embodiment, the door 20 and the cabinet 10 of the smart vending apparatus form a closed space, the items for sale carrying respective item information tags are arranged on the at least one layer of product shelves 102 in the cabinet 10, the door 20 of the smart vending apparatus is normally in the closed state, and the identity information tag 202 of the smart vending apparatus is arranged on one side, facing away from inner space of the cabinet 10, of the door 20; in particular use, a user scans the identity information tag 202 with a mobile terminal apparatus to acquire the identity information of the smart vending apparatus so as to be associated to purchase the items for sale, specifically, the acquired identity information is sent to a server associated with both the smart vending apparatus and the mobile terminal apparatus, when the server authenticates the identity information, a door-opening instruction is sent to the central processor 302 of the main control system 30 via the communication device 306 of the main control system 30 of the smart terminal apparatus, then the central processor 302 controls the door 20 of the smart vending apparatus to be opened to allow the user to take away an item for sale to be purchased, and after the user takes away the item and the door 20 is closed, the tag scanner 304 of the main control system 30 scans item information tags corresponding to all remaining items for sale currently on the product shelf 102 to figure out current inventory information in the smart vending apparatus and stores the current inventory information obtained each time into the memory device 314; in this way, an inventory of items for sale in the smart vending apparatus is able to be acquired with one tag scanner 304 provided therein, and the smart vending apparatus allows a user to select an item he/she needs by opening the door 20 of the smart vending apparatus, so that a transmission mechanism for outputting the item selected by the user from the smart vending apparatus is not needed, and accordingly it is not necessary to fix the items for sale at specific positions of the product shelf 102 for the sake of accurate output of the transmission mechanism, thereby greatly expanding the storage space of the smart vending apparatus, reducing the production cost of the apparatus, facilitating users' purchase operation with simplicity and convenience, effectively improving user experience and providing great convenience for the life of users; besides, in order to ensure that radio frequency signals within the closed space formed by the door 20 and the cabinet 10 do not leak to the outside to cause mistake scanning of items, the outer housing 104 of the cabinet 10, the cabinet side frame 106, and the door side frame 204 and the transparent window 206 of the door 20 are all configured to provide an electromagnetic shielding effect, and the sealing ring 70 provided between the door side frame 204 and the cabinet side frame 106 also provides an electromagnetic shielding effect, so that when the door 20 is closed, an electromagnetic shielded space without any electromagnetic leakage gaps is formed within the smart vending apparatus, while the inner wall 108 of the cabinet 10 is made of non-metallic material without an electromagnetic shielding effect and will not influence item settlement, thereby achieving a good signal shielding effect of the smart vending apparatus as well as a low error rate in item settlement, and thus improving the safety coefficient of the apparatus.

Specifically, the outer housing 104 and the cabinet side frame 106 of the cabinet 10 and the door side frame 204 and the transparent window 206 of the door 20 are made by doping electromagnetic shielding materials, such as at least one of carbon powder, nickel-plated graphite, silver-plated aluminum, silver-plated copper or silver-plated glass; through the transparent window 206 centrally provided on the door 20, a user can conveniently identify the types of items for sale placed on the product shelf 102 of the smart vending apparatus; and the identity information of the smart vending apparatus, which is a piece of encrypted information, is decrypted by the mobile terminal apparatus or the server.

Wherein, the item information tags carried by and in one-to-one correspondence to the items for sale comprise information such as names, prices, categories, valid periods and the like, and the identity information contained in the identity information tag 202 of the smart vending apparatus may be information such as an apparatus number corresponding to the smart vending apparatus and the like which is unique for the identity of the smart vending apparatus; the door-opening instruction is generated when the server authenticates the identity information of the smart vending apparatus and also authenticates identity information of the user and determines that a previous charge settlement of the user is completed, and the identity information of the user comprises WeChat account information and/or Alipay account information; and further, the current inventory information stored in the memory device 314 may be stored alternatively by overwriting so as to save storage space.

Further, the sealing ring 70 in the above embodiment specifically comprises at least the following two types:

### Specific Embodiment 1

In this specific embodiment, the sealing ring 70 is made of conductive rubber and is installed on the door side frame 204 and/or the cabinet side frame 106 through snapping-in, bonding or screw fixing.

It will be appreciated that, the sealing ring 70 may be specifically made of conductive rubber, and as conductive rubber is formed by conductive particles, such as silver-plated glass, silver-plated aluminum, silver, etc., uniformly distributed in silicone rubber, a good conductive property may be achieved by forcing the conductive particles into contact under pressure, thereby providing both sealing and electromagnetic shielding effects; and the conductive rubber may be installed on the door side frame 204 and/or the cabinet side frame 106 in various ways.

### Specific Embodiment 2

In this specific embodiment, the sealing ring 70 is made of a metal braided hose with a flexible plastic tube inserted therein, and the metal braided hose is installed on the door side frame 204 and/or the cabinet side frame 106 through bonding or screw fixing.

It will be appreciated that, the sealing ring 70 is formed by inserting the flexible plastic tube into the metal braided hose, thereby providing both sealing and electromagnetic shielding effects; and the metal braided hose may be installed on the door side frame 204 and/or the cabinet side frame 106 in various ways.

Of course, in other embodiments of the present disclosure, the sealing ring 70 may be made from other materials providing sealing and electromagnetic shielding effects.

Further, in the above embodiment, specifically, a sold item may be determined and charge settlement may be carried out in one of the following two ways:

### Specific Embodiment 1

In this specific embodiment, the central processor 302 is further used to compare the current inventory information with stored historical inventory information to determine a sold item taken away by a user after the door 20 is switched from the closed state to the open state, and the communication device 306 is further used to send item information of the sold item to the server to allow the server to generate corresponding charging information according to the item information of the sold item and carry out charge settlement with the mobile terminal apparatus according to the charging information.

It will be appreciated that, the central processor 302 of the smart vending apparatus determines a sold item taken away by the user (i.e., an item removed from the cabinet 10 at the current time) according to comparison between the current remaining inventory information after the user takes away the sold item and the historical inventory information, and the item information (such as quantity and price) in the item information tag corresponding to the sold item is sent by the communication device 306 to the server to allow the server to generate charging information about the sold item; and further, a charge operation for the sold item is specifically completed by the server to carry out charge settlement with the mobile terminal apparatus of the user according to the generated charging information, so that the user pays after taking out the item to be purchased, and the situation that the user cannot normally take the item after paying due to failure of the transmission mechanism in the existing vending apparatus is able to be effectively prevented, thereby further improving the user experience.

### Specific Embodiment 2

In this specific embodiment, the communication device 306 is further used to send the current inventory information to the server to allow the server to compare the current inventory information with historical inventory information before the door 20 is opened to determine a sold item, generate corresponding charging information according to item information of the sold item, and carry out charge settlement with the mobile terminal apparatus according to the charging information.

It will be appreciated that, the current inventory information in the smart vending apparatus is directly sent by the communication device 306 to the server to determine the sold item, that is, the server determines the sold item taken away by the user according to comparison between the current remaining inventory information after the user takes away the sold item and the historical inventory information, and further generates charging information of the sold item according to the item information in the item information tag corresponding to the sold item; and a charge operation for the sold item is specifically completed by the server to carry out charge settlement with the mobile terminal apparatus of the user according to the generated charging information, so that the user pays after taking out the item to be purchased, and the situation that the user cannot normally take the item after paying due to failure of the transmission mechanism in the existing vending apparatus is able to be effectively prevented, thereby further improving the user experience.

Further, in the two specific embodiments, in order to improve the efficiency of payment for the items, a safe and convenient password-free payment service may be provisioned between the mobile terminal apparatus and the server, thereby simplifying transaction operation and achieving convenience in use.

Further, as shown in FIG. 1, the main control system 30 in the above embodiment further comprises: a power supply device 308, a load control device 310 and a detection device 312.

Wherein, the power supply device 308 is used to provide a working power supply for the central processor 302, the load control device 310, the communication device 306 and the tag scanner 304; the load control device 310 is connected to the central processor 302; and the detection device 312 is connected to the central processor 302 and is used to detect work environment parameters within the cabinet 10 and an open/closed state of the door 20.

In this embodiment, the main control system 30 of the smart vending apparatus further comprises the load control device 310 for controlling on/off states of relevant components of the smart vending apparatus according to relevant control instructions of the central processor 302, and the detection device 312 for detecting work environment parameters within the cabinet 10 of the smart vending apparatus and an open/closed state of the door 20, so that the environment condition within the cabinet 10 is able to be adjusted in real time to provide a proper storage environment for items for sale therein so as to ensure the quality of the items, and the current inventory information in the smart vending apparatus is able to be figured out in time according to the switch of the open/closed state of the door 20; furthermore, the main control system 30 further comprises the power supply device 308 used to provide a working power supply for the central processor 302, the load control device 306, the communication device 310 and the tag scanner 304, and specifically, the power supply device 308 may obtain power from commercial power.

Further, as shown in FIG. 1, the smart vending apparatus in the above embodiment further comprises: a lock closing mechanism 40 provided at a middle position of the handle 208 and connected to the load control device 310, wherein the load control device 310 is used to control an open/closed state of the lock closing mechanism 40, the lock closing mechanism 40 comprises a main lock part 402 and a lock catch 406, wherein the main lock part 402 is installed on the cabinet 10, and the lock catch 406 is installed on the door 20.

In this embodiment, the cabinet 10 and the door 20 of the smart vending apparatus may be opened and closed through cooperation of the main lock part 402 and the lock catch 406 of the lock closing mechanism 40, specifically, the lock closing mechanism 40 is correspondingly opened or closed when the load control device 310 receives a corresponding unlocking or locking instruction from the central processor 302 so as to ensure the safety of items for sale in the cabinet 10 of the smart vending apparatus and prevent unnecessary loss to merchants, wherein the main lock part 402 and the lock catch 406 of the lock closing mechanism 40 may be optionally provided on the cabinet 10 and the door 20, respectively.

Further, as shown in FIG. 1, the smart vending apparatus in the above embodiment further comprises a lighting device 50 provided within the cabinet 10 and connected to the load control device 310, wherein the load control device 310 is used to control an on/off state of the lighting device 50.

In this embodiment, in order to meet shopping needs of users in a dark environment with poor light, the smart vending apparatus may be provided with a lighting device 50, such as an LED lighting lamp and the like, and specifically, the lighting device 50 is correspondingly turned on or off when the load control device 310 receives a corresponding light-on or light-off instruction from the central processor 302.

It will be appreciated that, the lighting device 50 of the smart vending apparatus may always be in a lighting work state when the smart vending apparatus is in a dark environment with poor light, or may enter the lighting work state when the door 20 of the smart vending apparatus is opened and stop lighting when the door 20 is locked with the cabinet 10.

Further, as shown in FIG. 1, the smart vending apparatus in the above embodiment further comprises a cooling system 60 provided within the cabinet 10 and connected to the load control device 310, wherein the load control device 310 is used to control an on/off state of the cooling system 60.

In this embodiment, in order to meet quality guarantee and fresh-keeping demands of items for sale placed in the cabinet 10 of the smart vending apparatus, the smart apparatus may be provided with a cooling system 60 to appropriately lower the environment temperature within the cabinet 10, and specifically, the cooling system 60 correspondingly starts cooling or stops cooling when the load control device 310 receives a corresponding start or stop instruction from the central processor 302.

Specifically, the detection device 312 may be a sensor, such as a temperature sensor for detecting the temperature in the cabinet 10 of the smart vending apparatus, a humidity sensor for detecting the humidity in the cabinet 10, a pressure sensor for detecting whether the door 20 is closed or not, etc.

Further, in the above embodiments, the item information tag comprises an RFID tag, and the tag scanner 304 is an RFID scanner.

In this embodiment, the corresponding tag scanner 304 and item information tags may be configured as an RFID scanner and RFID tags, respectively, so as to identify a specific target and read and write relevant data by means of radio signals based on the radio frequency identification technology without establishing mechanical or optical contact between the tag scanner 304 and the item information tags, so that the completeness of remaining items for sale in the cabinet 10 scanned by the tag scanner 304 is ensured, and thus generated inventory information is highly accurate.

Further, in the above embodiments, the identity information tag 202 comprises a two-dimensional code or NFC.

In this embodiment, the identity information tag 202 which is provided on the door 20 and contains the identity information of the smart vending apparatus may be presented in a form of a two-dimensional code or NFC so as to facilitate near field scanning identification by the mobile terminal apparatus of the user; and of course, the identity information tag may also be in a form of a tag which is able to be identified by the mobile terminal apparatus, such as an RFID tag, an optical tag, etc.

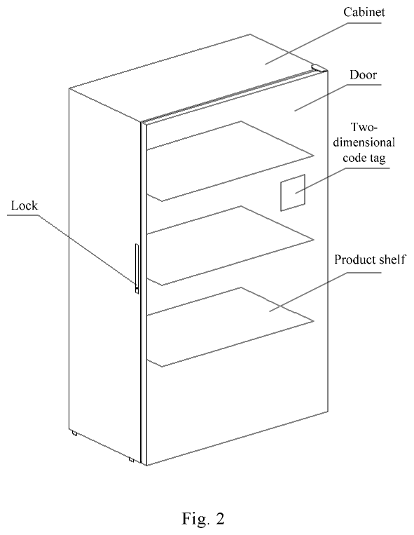

As shown in FIG. 2, a smart vending apparatus according to a second embodiment of the present disclosure specifically comprises:

a cabinet provided with at least one layer of product shelves (three product shelves as shown in FIG. 2) suitable for placing goods (i.e., items for sale), wherein each item carries an RFID tag (i.e., an item information electronic tag), and each RFID tag contains relevant information, such as the name, specification and price, etc., of the corresponding goods;

a door connected to the cabinet, wherein a two-dimensional code tag (equivalent to the identity information tag shown in FIG. 1) containing identity information of the smart vending apparatus is fixed on the door, and further the door is transparent to enable a user to see the goods placed on the product shelves within the cabinet;

further, the cabinet side frame of the cabinet and the door both provide an electromagnetic shielding effect, while the cabinet has an inner wall made from a material without an electromagnetic shielding effect, so that when the door is closed, a closed electromagnetic shielded space is formed by the door and the cabinet; and a sealing ring may be optionally provided between the door side frame and the cabinet side frame, thereby further preventing items from being scanned mistakenly;

a lock (equivalent to the lock closing mechanism shown in FIG. 1), wherein a main part of the lock is mounted on the cabinet, and a lock catch is mounted on the door;

a lighting lamp (equivalent to the lighting device shown in FIG. 1) and a cooling system which are provided within the cabinet;

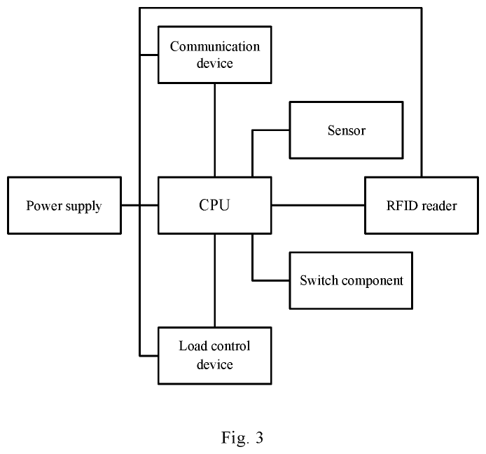

a main control system provided within the cabinet and specifically comprising the following components as shown in FIG. 3: a CPU (Central Processing Unit), a communication device connected to the CPU, a sensor and a switch component (equivalent to the detection device shown in FIG. 1), an RFID reader (equivalent to the tag scanner shown in FIG. 1), a load control device, and a power supply device used to provide a working power supply for the CPU, the communication device, the RFID reader and the load control device.

Wherein, the load control device controls an open/closed state of the lock, an on/off state of the lighting lamp and a work state of an electric device of the cooling system; the communication device is provided with an external antenna and is used to maintain connection and communication between the smart vending apparatus and the server; the RFID reader is provided with at least one antenna and is responsible for reading RFID tag information of the items on the product shelves of the cabinet; and the switch component is used to sense the open/closed state of the lock so as to allow the CPU to inform the RFID reader to read the RFID tag information of the items when the switch component senses that the lock is switched from the open state to the closed state.

In a specific intelligent self-service vending application, a two-dimensional code tag on the smart vending apparatus is scanned with a mobile terminal apparatus of a user to obtain identity information of the smart vending apparatus, the server authenticates the identity information and then sends an unlocking instruction to the main control system, the main control system controls the lock to be opened after receiving the unlocking instruction from the server, and the main control system closes the lock after detecting a door closing signal and informs the RFID reader to work, i.e., to read all RFID tag information in the apparatus to determine current inventory, compares the current inventory with a previous inventory to determine an item that has been removed, and informs a charge settlement system of the server to carry out settlement.

Further, the smart vending apparatus according to any of the above embodiments may be a smart refrigerator such as a shared refrigerator.

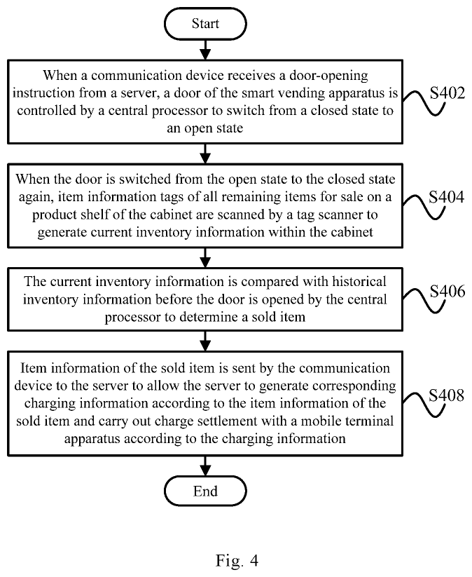

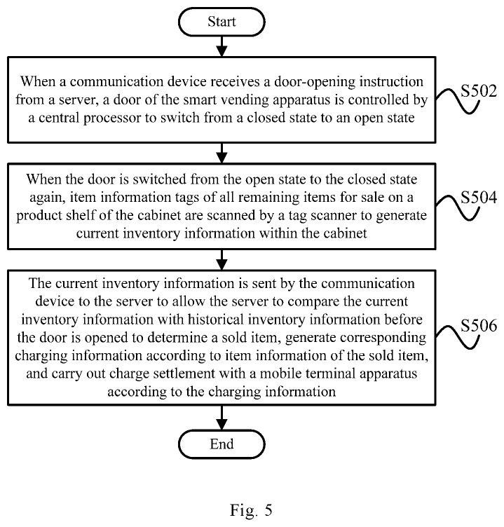

A control method of the above-described smart vending apparatus will be described with reference to FIGS. 4 and 5, and may be implemented according to one of the following two embodiments:

### Embodiment 1

As shown in FIG. 4, the control method of the smart vending apparatus according to the first embodiment of the disclosure is illustrated and is used for the smart vending apparatus according to any one of the embodiments, and the control method specifically comprises the following steps that:

Step S402, when a communication device receives a door-opening instruction from a server, a door of the smart vending apparatus is controlled by a central processor to switch from a closed state to an open state.

Step S404, when the door is switched from the open state to the closed state again, item information tags of all remaining items for sale on a product shelf of the cabinet are scanned by a tag scanner to generate current inventory information within the cabinet.

Step S406, the current inventory information is compared with historical inventory information before the door is opened by the central processor to determine a sold item.

Step S408, item information of the sold item is sent by the communication device to the server to allow the server to generate corresponding charging information according to the item information of the sold item and carry out charge settlement with a mobile terminal apparatus according to the charging information.

In this embodiment, when a user needs to purchase an item for sale in the cabinet of the smart vending apparatus, the central processor controls the door of the smart vending apparatus to be opened when the communication device receives the door-opening instruction sent by the server to allow the user to take away the item for sale to be purchased, and after the user takes away the item and the door is closed, the tag scanner of the main control system scans item information tags corresponding to all remaining items for sale currently on the product shelf to figure out current inventory information in the smart vending apparatus; besides, the outer housing and the cabinet side frame of the cabinet and the door side frame and the transparent window of the door of the smart vending apparatus are all configured to provide an electromagnetic shielding effect, and a sealing ring provided between the door side frame and the cabinet side frame also provide an electromagnetic shielding effect, so that when the door is closed, an electromagnetic shielded space without any electromagnetic leakage gaps is formed within the smart vending apparatus, and it is ensured that radio frequency signals within the closed space formed by the door and the cabinet do not leak to the outside to cause mistake scanning of items, while the inner wall of the cabinet is made of non-metallic material without an electromagnetic shielding effect and will not influence item settlement, thereby achieving a good signal shielding effect of the smart vending apparatus as well as a low error rate in item settlement, and thus improving the safety coefficient of the apparatus; in this way, an inventory of items for sale in the smart vending apparatus is able to be acquired with one tag scanner provided therein, and the smart vending apparatus allows a user to select an item he/she needs by opening the door of the smart vending apparatus, so that a transmission mechanism for outputting the item selected by the user from the smart vending apparatus is not needed, and accordingly it is not necessary to fix the items for sale at specific positions of the product shelf for the sake of accurate output of the transmission mechanism, thereby greatly expanding the storage space of the smart vending apparatus, reducing the production cost of the apparatus, facilitating users' purchase operation with simplicity and convenience, effectively improving user experience and providing convenience for the life of users.

Further, the central processor of the smart vending apparatus may determine a sold item taken away by the user (i.e., an item removed from the cabinet at the current time) according to comparison between the current remaining inventory information after the user takes away the sold item and the historical inventory information, and the item information (such as quantity and price) in the item information tag corresponding to the sold item is sent by the communication device to the server; and a charge operation for the sold item is specifically completed by the server to carry out charge settlement with the mobile terminal apparatus of the user according to the generated charging information, so that the user pays after taking out the item to be purchased, and the situation that the user cannot normally take the item after paying due to failure of the transmission mechanism in the existing vending apparatus is able to be effectively prevented, thereby further improving the user experience.

Further, in the above embodiments, the item information tags carried by and in one-to-one correspondence to the items for sale comprise information such as names, prices, categories, valid periods and the like, and the identity information contained in the identity information tag of the smart vending apparatus may be information such as an apparatus number corresponding to the smart vending apparatus and the like which is unique for the identity of the smart vending apparatus; wherein, the item information tag comprises an RFID tag, the tag scanner is an RFID scanner, and the identity information tag comprises a two-dimensional code or NFC.

Further, in the above embodiments, the door-opening instruction is generated when the server authenticates identity information of a user, determines that a previous charge settlement of the user is completed and authenticates identity information of the smart vending apparatus that the mobile terminal apparatus acquires by scanning an identity information tag on the door, wherein the identity information of the user comprises WeChat account information and/or Alipay account information.

In this embodiment, before the smart vending apparatus opens its door according to a door-opening instruction, a user needs to scan an identity information tag provided on the door of the smart vending apparatus with his/her a mobile terminal apparatus to obtain identity information of the smart vending apparatus, and the identity information is sent to a server associated with both the mobile terminal apparatus and the smart vending apparatus for authentication, and when the server authenticates the identity information and also authenticates identity information of the user and determines that a previous charge settlement of the user is completed, a corresponding door-opening instruction is generated, so that the accuracy of charging is ensured, the user is prompted to settle the charge in time, and the loss of merchants is reduced; wherein, the identity information of the smart vending apparatus is optionally a piece of encrypted information, and further, the encrypted identity information of the smart vending apparatus may be decrypted by the mobile terminal apparatus or the server.

Further, in the above embodiment, in order to improve the efficiency of payment for the items, a safe and convenient password-free payment service may be provisioned between the mobile terminal apparatus and the server, thereby simplifying transaction operation and achieving convenience in use.

Further, in the above embodiment, after the current inventory information within the cabinet is generated in step S404, the control method of the smart vending apparatus further comprises the following method steps as shown in the following two specific embodiments:

### Specific Embodiment 1

In this specific embodiment, the control method further comprises the following steps that: whether a quantity of items contained in the current inventory information is smaller than a preset quantity threshold or not is detected; and if so, it prompts to replenish the smart vending apparatus with items for sale.

In this embodiment, whether to prompt a merchant to make replenishment or not may be determined according to a result of comparison between the quantity of items contained in the current inventory information which is figured out and generated after each sale and a preset quantity threshold, and specifically, it may prompt that the smart vending apparatus needs replenishment with the items for sale when the quantity of the items is smaller than the preset quantity threshold, thereby ensuring sufficient supply of the items for sale stored in the cabinet of the smart vending apparatus.

Wherein, the value of the preset quantity threshold may be specifically set according to the volume capacity of the cabinet of the smart vending apparatus so as to facilitate inventory statistics of items for sale.

### Specific Embodiment 2

In this specific embodiment, the control method further comprises the following steps that: according to a quantity of items contained in the current inventory information and a consumption rate of the items, a replenishment time to replenish the smart vending apparatus with items for sale is prompted.

In this embodiment, a replenishment time to replenish the smart vending apparatus with items for sale may be prompted according to the quantity of items contained in the current inventory information which is figured out and generated after each sale and the consumption rate of the items, so that the smart vending apparatus is able to be replenished in time before the items for sale are sold out, thereby ensuring sufficient supply of the items for sale stored in the cabinet of the smart vending apparatus.

### Embodiment 2

As shown in FIG. 5, the control method of the smart vending apparatus according to the second embodiment of the disclosure is illustrated and is used for the smart vending apparatus according to any one of the embodiments, and the control method specifically comprises the following steps that:

Step S502, when a communication device receives a door-opening instruction from a server, a door of the smart vending apparatus is controlled by a central processor to switch from a closed state to an open state.

Step S504, when the door is switched from the open state to the closed state again, item information tags of all remaining items for sale on a product shelf of the cabinet are scanned by a tag scanner to generate current inventory information within the cabinet.

Step S506, the current inventory information is sent by the communication device to the server to allow the server to compare the current inventory information with historical inventory information before the door is opened to determine a sold item, generate corresponding charging information according to item information of the sold item, and carry out charge settlement with a mobile terminal apparatus according to the charging information.

In this embodiment, when a user needs to purchase an item for sale in the cabinet of the smart vending apparatus, the central processor controls the door of the smart vending apparatus to be opened when the communication device receives the door-opening instruction sent by the server to allow the user to take away the item for sale to be purchased, and after the user takes away the item and the door is closed, the tag scanner of the main control system scans item information tags corresponding to all remaining items for sale currently on the product shelf to figure out current inventory information in the smart vending apparatus; besides, the outer housing and the cabinet side frame of the cabinet and the door side frame and the transparent window of the door of the smart vending apparatus are all configured to provide an electromagnetic shielding effect, and a sealing ring provided between the door side frame and the cabinet side frame also provide an electromagnetic shielding effect, so that when the door is closed, an electromagnetic shielded space without any electromagnetic leakage gaps is formed within the smart vending apparatus, and it is ensured that radio frequency signals within the closed space formed by the door and the cabinet do not leak to the outside to cause mistake scanning of items, while the inner wall of the cabinet is made of non-metallic material without an electromagnetic shielding effect and will not influence item settlement, thereby achieving a good signal shielding effect of the smart vending apparatus as well as a low error rate in item settlement, and thus improving the safety coefficient of the apparatus; in this way, an inventory of items for sale in the smart vending apparatus is able to be acquired with one tag scanner provided therein, and the smart vending apparatus allows a user to select an item he/she needs by opening the door of the smart vending apparatus, so that a transmission mechanism for outputting the item selected by the user from the smart vending apparatus is not needed, and accordingly it is not necessary to fix the items for sale at specific positions of the product shelf for the sake of accurate output of the transmission mechanism, thereby greatly expanding the storage space of the smart vending apparatus, reducing the production cost of the apparatus, facilitating users' purchase operation with simplicity and convenience, effectively improving user experience and providing convenience for the life of users.

Further, the current inventory information in the smart vending apparatus may be directly sent by the communication device of the smart vending apparatus to the server to determine the sold item, that is, the server determines the sold item taken away by the user according to comparison between the current remaining inventory information after the user takes away the sold item and the historical inventory information, and further generates charging information of the sold item according to the item information in the item information tag corresponding to the sold item; and a charge operation for the sold item is specifically completed by the server to carry out charge settlement with the mobile terminal apparatus of the user according to the generated charging information, so that the user pays after taking out the item to be purchased, and the situation that the user cannot normally take the item after paying due to failure of the transmission mechanism in the existing vending apparatus is able to be effectively prevented, thereby further improving the user experience.

Further, in the above embodiment, the item information tags carried by and in one-to-one correspondence to the items for sale comprise information such as names, prices, categories, valid periods and the like, and the identity information contained in the identity information tag of the smart vending apparatus may be information such as an apparatus number corresponding to the smart vending apparatus and the like which is unique for the identity of the smart vending apparatus; wherein, the item information tag comprises an RFID tag, the tag scanner is an RFID scanner, and the identity information tag comprises a two-dimensional code or NFC.

Further, in the above embodiment, the door-opening instruction is generated when the server authenticates identity information of a user, determines that a previous charge settlement of the user is completed and authenticates identity information of the smart vending apparatus that the mobile terminal apparatus acquires by scanning an identity information tag on the door, wherein the identity information of the user comprises WeChat account information and/or Alipay account information.

In this embodiment, before the smart vending apparatus opens its door according to a door-opening instruction, a user needs to scan an identity information tag provided on the door of the smart vending apparatus with his/her mobile terminal apparatus to obtain identity information of the smart vending apparatus, and the identity information is sent to a server associated with both the mobile terminal apparatus and the smart vending apparatus for authentication, and when the server authenticates the identity information and also authenticates identity information of the user and determines that a previous charge settlement of the user is completed, a corresponding door-opening instruction is generated, so that the accuracy of charging is ensured, the user is prompted to settle the charge in time, and the loss of merchants is reduced. Wherein, the identity information of the smart vending apparatus is optionally a piece of encrypted information, and further, the encrypted identity information of the smart vending apparatus may be decrypted by the mobile terminal apparatus or the server.

Further, in the above embodiment, in order to improve the efficiency of payment for the items, a safe and convenient password-free payment service may be provisioned between the mobile terminal apparatus and the server, thereby simplifying transaction operation and achieving convenience in use.

Further, in the above embodiment, after the current inventory information within the cabinet is generated in step S504, the control method of the smart vending apparatus further comprises the following method steps as shown in the following two specific embodiments:

### Specific Embodiment 1

In this specific embodiment, the control method further comprises the following steps that: whether a quantity of items contained in the current inventory information is smaller than a preset quantity threshold or not is detected; and if so, it prompts to replenish the smart vending apparatus with items for sale.

In this embodiment, whether to prompt a merchant to make replenishment or not may be determined according to a result of comparison between the quantity of items contained in the current inventory information which is figured out and generated after each sale and a preset quantity threshold, and specifically, it may prompt that the smart vending apparatus needs replenishment with the items for sale when the quantity of the items is smaller than the preset quantity threshold, thereby ensuring sufficient supply of the items for sale stored in the cabinet of the smart vending apparatus.

Wherein, the value of the preset quantity threshold may be specifically set according to the volume capacity of the cabinet of the smart vending apparatus so as to facilitate inventory statistics of items for sale.

### Specific Embodiment 2

In this specific embodiment, the control method further comprises the following steps that: according to a quantity of items contained in the current inventory information and a consumption rate of the items, a replenishment time to replenish the smart vending apparatus with items for sale is prompted.

In this embodiment, a replenishment time to replenish the smart vending apparatus with items for sale may be prompted according to the quantity of items contained in the current inventory information which is figured out and generated after each sale and the consumption rate of the items, so that the smart vending apparatus is able to be replenished in time before the items for sale are sold out, thereby ensuring sufficient supply of the items for sale stored in the cabinet of the smart vending apparatus.

Further, the control method described in the first embodiment and the second embodiment specifically comprises the following steps that: when power-on of the smart vending apparatus is detected, a first start instruction is sent by the central processor to the load control device of the smart vending apparatus, and the load control device starts the cooling system of the smart vending apparatus according to the first start instruction; and when power-off of the smart vending apparatus is detected, a first stop instruction is sent by the central processor to the load control device of the smart vending apparatus, and the load control device stops the cooling system of the smart vending apparatus according to the first stop instruction.

Further, the control method, described above in the first embodiment shown in FIG. 4 and the second embodiment shown in FIG. 5, specifically further comprises the following steps that:

when an environmental brightness of an environment space where the smart vending apparatus is located is detected to be lower than or equal to a preset brightness threshold, a first start instruction may be sent by the central processor to the load control device of the smart vending apparatus, and the load control device starts the lighting device of the smart vending apparatus according to the first start instruction; and if the environmental brightness is higher than the preset brightness threshold, a first stop instruction may be sent by the central processor to the load control device of the smart vending apparatus, and the load control device stops the lighting device of the smart vending apparatus according to the first stop instruction.

Alternatively, when the door of the smart vending apparatus is detected to be opened, a third start instruction is sent by the central processor to the load control device of the smart vending apparatus, and the load control device starts the lighting device of the smart vending apparatus according to the third start instruction; and when the door is closed, a third stop instruction is sent by the central processor to the load control device of the smart vending apparatus, and the load control device stops the lighting device of the smart vending apparatus according to the third stop instruction.

Wherein, the lighting device of the smart vending apparatus may be an LED lighting lamp and the like.

The steps of the control method in the above embodiment are able to be implemented by executing corresponding program instructions by a central processor in the main control system of the smart vending apparatus.

According to an embodiment of the present disclosure, a computer readable storage medium having stored thereon a computer program which, when executed by a processor, carries out the steps of the control method of the smart vending apparatus as described in any one of the above embodiments, is provided.

Further, it is to be understood that any process or method description in the flowchart or otherwise described herein may be understood to represent devices, segments, or portions of code comprising one or more executable instructions for implementing the steps of a particular logical function or process, and that the scope of the preferred embodiments of the disclosure includes additional implementations, in which functions may be performed out of the order shown or discussed, including in a substantially simultaneous manner or in a reverse order depending on the functionality involved, as will be appreciated by those skilled in the art to which the embodiments of the disclosure pertain.

Logic and/or steps shown in the flowcharts or otherwise described herein, for example, as an ordered listing of executable instructions that may be considered to implement logical functions, may be embodied in any computer-readable medium for use by or in connection with an instruction execution system, apparatus, or device (e.g., a computer-based system, a system that includes a processor, or other system that can fetch instructions from the instruction execution system, apparatus, or device and execute the instructions). For the purposes of this specification, a “computer-readable medium” is able to be any means that can contain, store, communicate, propagate, or transport the program for use by or in connection with the instruction execution system, apparatus, or device. More specific examples (a non-exhaustive list) of the computer-readable medium include the following: an electrical connection having one or more wiring lines (electronic device), a portable computer cartridge (magnetic device), a random access memory (RAM), a read-only memory (ROM), an erasable programmable read-only memory (EPROM or Flash memory), an optical fiber device, and a portable compact disc read-only memory (CDROM). In addition, the computer-readable medium may even be paper or other suitable medium upon which the program is printed, as the program may be electronically obtained, such as by optically scanning the paper or other medium, followed by editing, interpreting, or otherwise processing in a suitable manner if necessary, and then stored in a computer memory.

It is to be understood that portions of the present disclosure may be implemented in hardware, software, firmware, or a combination thereof. In the embodiments described above, the steps or methods may be implemented in software or firmware stored in memory and executed by a suitable instruction execution system. For example, if implemented in hardware, as in another embodiment, it may be implemented using any one or a combination of the following techniques known in the art: discrete logic circuits with logic gates for implementing logic functions on data signals, application specific integrated circuits with appropriate combinational logic gates, programmable gate arrays (PGAs), field programmable gate arrays (FPGAs), etc.

It will be appreciated by those skilled in the art that all or a portion of the steps carried by a method of implementing the above-described embodiments may be performed by program instructions associated with hardware, which may be stored in a computer-readable storage medium, which when executed, comprises one or a combination of the steps of the method embodiments.

Furthermore, the functional units in the various embodiments of the present disclosure may be integrated in one processing device, may be physically separate units, or may be integrated in one device in two or more units. The integrated device is able to be realized in the form of hardware or software functional devices. The integrated device, if implemented in the form of a software functional device and sold or used as a stand-alone product, may also be stored in a computer-readable storage medium.

The above-mentioned storage medium may be a read-only memory, a magnetic or optical disk, or the like.

The technical solution of the present disclosure is described in detail above with reference to the drawings, in which the smart vending apparatus allows a user to open a door by scanning an identity information tag of the apparatus, select items for sale at will, and pay the items via a server, so that user operation is facilitated while a good signal shielding effect, a low error rate of item payment as well as a high safety factor are achieved, thereby effectively improving user experience.

In the embodiments of the present disclosure, the terms “first”, “second”, and “third” are used for descriptive purposes only and are not to be construed as indicating or implying relative importance, as the specific meaning of the above terms in the embodiments of the present disclosure may be understood by those skilled in the art, as the case may be.

The foregoing is merely preferred embodiments of the present disclosure and is not intended to be limiting of the disclosure, and it will be understood by those skilled in the art that various changes and modifications may be made therein. Any modifications, equivalents, improvements, etc., made within the spirit and principles of the disclosure are intended to be included within the scope of the present disclosure.

1. A smart vending apparatus, comprising:
a cabinet having an outer housing that includes an electromagnetic shielding property, a cabinet side frame that includes an electromagnetic shielding property, an inner wall of an non-metallic material without an electromagnetic shielding property, and at least one layer of product shelf in the cabinet structured to display items for sale, the items for sale carrying corresponding item information tags;
a door installed on the cabinet, the door including a door side frame at a peripheral portion of the door, a transparent window at a central portion of the door, and a handle positioned on the door side frame, the door side frame and the transparent window each including an electromagnetic shielding property forming a body without an electromagnetic leakage gap, and the door including an identity information tag to be scanned by a mobile terminal apparatus to acquire identity information of the smart vending apparatus;
a sealing ring between the door side frame and the cabinet side frame, the sealing ring having an electromagnetic shielding property, the cabinet, the door and the sealing ring forming a body without an electromagnetic leakage gap when the door is in a closed state; and
a main control system provided within the cabinet and including: a central processor, a memory device, a tag scanner and a communication device, the tag scanner and the communication device both connected to the central processor;
wherein the communication device is configured to establish a communication connection between the central processor and a server, and the central processor is configured to control the door to switch from the closed state to an open state upon receiving a door-opening instruction sent by the server after the server authenticates the identity information;
the tag scanner is configured to scan all item information tags in the cabinet, after the door is switched from the open state to the closed state, to determine current inventory information of the smart vending apparatus; and
the memory device is configured to store the current inventory information.

2. The smart vending apparatus according to claim 1, wherein:
the central processor is further configured to compare the current inventory information with stored historical inventory information to determine a sold item removed from the cabinet by a user after the door is switched from the closed state to the open state, and the communication device is further configured to send item information of the sold item to the server to allow the server to generate corresponding charging information according to the item information of the sold item and carry out charge settlement with the mobile terminal apparatus according to the charging information; or
the communication device is further used to send the current inventory information to the server to allow the server to compare the current inventory information with historical inventory information before the door is opened to determine the sold item, and generate corresponding charging information according to item information of the sold item, and carry out charge settlement with the mobile terminal apparatus according to the charging information.

3. The smart vending apparatus according to claim 1, wherein the main control system further comprises: a power supply device, a load control device and a detection device;
wherein the power supply device is configured to provide a working power supply for the central processor, the load control device, the communication device and the tag scanner;
the load control device is connected to the central processor; and
the detection device is connected to the central processor and is configured to detect a work environment parameter within the cabinet and an open or a closed state of the door.

4. The smart vending apparatus according to claim 3, further comprising:
a lock closing mechanism provided at a middle position of the handle and connected to the load control device, wherein the load control device is configured to control an open and a closed state of the lock closing mechanism, the lock closing mechanism includes a main lock part and a lock catch, the main lock part is installed on the cabinet, and the lock catch is installed on the door.

5. The smart vending apparatus according to claim 3, further comprising: a lighting device provided within the cabinet and connected to the load control device, wherein the load control device is configured to control an on state and an off state of the lighting device.

6. The smart vending apparatus according to claim 3, further comprising: a cooling system provided within the cabinet and connected to the load control device, wherein the load control device is configured to control an on state and an off state of the cooling system.

7. The smart vending apparatus according to claim 1, wherein the item information tags comprise an RFID tag, and the tag scanner is an RFID scanner.

8. The smart vending apparatus according to claim 1, wherein the identity information tags comprise a two-dimensional code or a near field communication unit.

9. The smart vending apparatus according to claim 1, wherein the sealing ring includes conductive rubber and is installed on one or more of the door side frame or the cabinet side frame through one or more of snapping-in, bonding or screw fixing.

10. The smart vending apparatus according to claim 1, wherein the sealing ring includes a metal braided hose with a flexible plastic tube inserted therein, and the metal braided hose is installed on one or more of the door side frame or the cabinet side frame through one or more of bonding or screw fixing.

11. A control method for a smart vending apparatus, the control method comprising the following acts of:
receiving, via a communication device of the smart vending apparatus, a door-opening instruction from a server;
in response to the communication device receiving the door-opening instruction from the server, controlling, by a central processor of the smart vending apparatus, a door of the smart vending apparatus to switch from a closed state to an open state;
detecting, by a detection device of the smart vending apparatus, that the door has been switched from the open state back to the closed state;
in response to the detecting that the door has been switched from the open state back to the closed state, scanning, by a tag scanner of the smart vending apparatus, item information tags of all items for sale on a product shelf of the smart vending apparatus to generate current inventory information;
comparing, by the central processor, the current inventory information with historical inventory information stored before the controlling the door to switch from the closed state to the open state to determine a sold item; and
sending, by the communication device, item information of the sold item to the server to allow the server to generate corresponding charging information according to the item information of the sold item and carry out charge settlement with a mobile terminal apparatus according to the charging information.

12. A control method for a smart vending apparatus, the control method comprising the following acts of:
receiving, via a communication device of the smart vending apparatus, a door-opening instruction from a server;
in response to the communication device receiving the door-opening instruction from the server, controlling, by a central processor of the smart vending apparatus, a door of the smart vending apparatus to switch from a closed state to an open state;
detecting, by a detection device of the smart vending apparatus, that the door has been switched from the open state back to the closed state;
in response to the detecting that the door has been switched from the open state back to the closed state, scanning, by a tag scanner of the smart vending apparatus, item information tags of all items for sale on a product shelf of the smart vending apparatus to generate current inventory information; and
sending, by the communication device, the current inventory information to the server to allow the server to compare the current inventory information with historical inventory information to determine a sold item, generate corresponding charging information according to item information of the sold item, and carry out charge settlement with a mobile terminal apparatus according to the charging information.

13. The control method to claim 11, wherein
the door-opening instruction is generated in response to that the server authenticates identity information of a user, determines that a previous charge settlement of the user is completed and authenticates identity information of the smart vending apparatus that the mobile terminal apparatus acquires by scanning an identity information tag on the door.

14. The control method according to claim 11, wherein after the current inventory information within the smart vending apparatus is generated, the method further comprises the following acts of:
detecting that a quantity of items contained in the current inventory information is smaller than a preset quantity threshold; and
prompting to replenish the smart vending apparatus with items for sale.

15. The control method according to claim 11, wherein after the current inventory information within the cabinet is generated, the method further comprises the following act of:
determining a quantity of items contained in the current inventory information;
determining a consumption rate of the items based on the quantity of items; and
prompting a replenishment time to replenish the smart vending apparatus with items for sale based on the a quantity of items and the consumption rate.

16. The control method according to claim 12, wherein
the door-opening instruction is generated in response to that the server authenticates identity information of a user, determines that a previous charge settlement of the user is completed and authenticates identity information of the smart vending apparatus that the mobile terminal apparatus acquires by scanning an identity information tag on the door.

17. The control method according to claim 12, wherein after the current inventory information within the smart vending apparatus is generated, the method further comprises the following acts of:
detecting that a quantity of items contained in the current inventory information is smaller than a preset quantity threshold; and
prompting to replenish the smart vending apparatus with items for sale.

18. The control method according to claim 12, wherein after the current inventory information within the cabinet is generated, the method further comprises the following acts of:
determining a quantity of items contained in the current inventory information;
determining a consumption rate of the items based on the quantity of items; and
prompting a replenishment time to replenish the smart vending apparatus with items for sale based on the a quantity of items and the consumption rate.
